(19) United States
(12) Patent Application Publication
(10) Pub. No.: US 2012/0239229 A1
(43) Pub. Date: Sep. 20, 2012

(54) SYSTEM AND METHOD FOR TRANSPORTING GOODS

(75) Inventors: CHI-CHIH WANG, Tu-Cheng (TW); RUI-JUN WANG, Shenzhen City (CN); YAO-FENG LI, Shenzhen City (CN); ZHI-LONG LI, Shenzhen City (CN)

(73) Assignees: HON HAI PRECISION INDUSTRY CO., LTD., Tu-Cheng (TW); GDS SOFTWARE (SHENZHEN) CO.,LTD, ShenZhen City (CN)

(21) Appl. No.: 13/249,241

(22) Filed: Sep. 30, 2011

(30) Foreign Application Priority Data
Mar. 15, 2011 (CN) 201110062106.0

(51) Int. Cl. G05D 1/02; G06F 19/00

(52) U.S. Cl. 701/19

(57) ABSTRACT

An identification device reads an identification number from a tag of goods which are transported on an input guide rail. An application server receives the identification number from the identification device. The application server searches for a serial number of a designated output guide rail according to the identification number. When the goods are transported to an intersection of the input guide rail and the designated output guide rail. The goods are carried onto the designated output guide rail. The application serer controls the goods to be transported to a destination station along the designated output guide rail.

### BACKGROUND

1. Technical Field

Embodiments of the present disclosure generally relate to goods management, and more particularly to a system and method for transporting goods.

2. Description of Related Art

In production lines of factories, different kinds of goods, such as materials, semi-manufactured products, or finished products, are often needed to be transported from a start station to different destination stations. There is only one output guide rail between a start station and a destination station. Therefore, more than one output guide rail is needed for the transportation of the goods. At present, selecting the correct output guide rail for the goods is usually done manually, which is time-consuming and results in low efficiency.

### BRIEF DESCRIPTION OF THE DRAWINGS

FIG. 1 is a block diagram of one embodiment of an application server comprising a transportation system.

FIG. 2 is a block diagram of one embodiment of the function modules of the transportation system in FIG. 1.

FIG. 3 is a flowchart illustrating one embodiment of a method for transporting goods.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

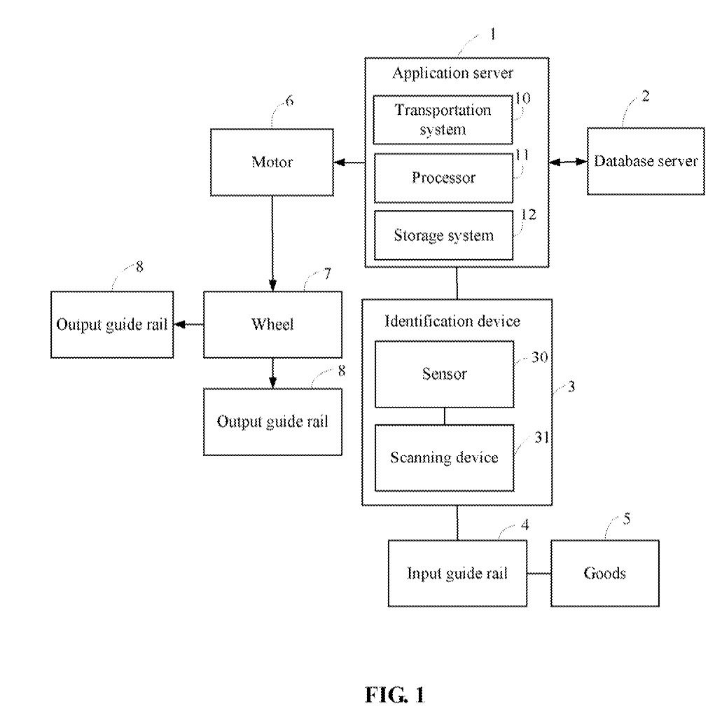

FIG. 1 is a block diagram of one embodiment of an application server 1 comprising a transportation system 10. The transportation system 10 is used to carry goods 5 from a starting station to a destination station. An input guide rail 4 and more than one output guide rails 8 are placed between the starting station and the destination station. The input guide rail 4 is a conveyer to receive the goods 5 from the starting station and transport the goods 5 to one of the more than one output guide rails 8. The output guide rail is a conveyer to receive the goods 5 from the input guide rail 4 and transport the goods 5 to the destination station. A wheel 7, which is connected to a motor 6, is placed between the input guide rail 4 and the more than one output guide rails 8. The wheel 7 can be driven by the motor 6 to rotate to transport the goods 5 to one of the more than one output guide rails 8.

The application server 1 is electrically connected to a database server 2, an identification device 3, and the motor 6. The identification device 3 recognizes a tag on the goods 5. In some embodiments, the goods 5 may be put on a pallet which has wheels and can move on the input guide rail 4 and each output guide rail 8. The tag may be a Radio Frequency Identification (RFID) tag and include an identification number. The identification device 3 includes a sensor 30 and a scanning device 31. If the sensor 30 detects the goods 5, the scanning device 31 scans the tag on the goods 5 to obtain the identification number, and sends the identification number to the application server 1. The database server 2 stores the identification number of the goods 5 and goods information of the goods 5. In one embodiment, the goods information may include names of the goods 5 and a serial number of a designated output guide rail 8 for carrying the goods 5 to the destination station. The application server 1 searches the goods information of the goods 5 in the database server 2 and determines the serial number of the designated output guide rail 8 of the goods 5 based on the identification number of the goods.

The motor 6 controls the wheel 7 to carry the goods to the designated output guide rail 8. The application server 1 sends the searched serial number to the motor 6. The motor 6 controls the wheel 7 to guide the goods to the designated output guide rail 8 corresponding to the searched serial number.

In an exemplary embodiment, the application server 1 includes at least one processor 11 and a storage system 12. The transportation system 10 may include one or more modules. The one or more modules may comprise computerized code in the form of one or more programs that are stored in the storage system 12 (or memory). In one embodiment, the storage system 12 may be a magnetic or an optical storage system, such as a hard disk drive, an optical drive, a compact disc, a digital video disc, a tape drive, or other suitable storage medium. The computerized code includes instructions that are executed by the at least one processor 11 to provide functions for the one or more modules.

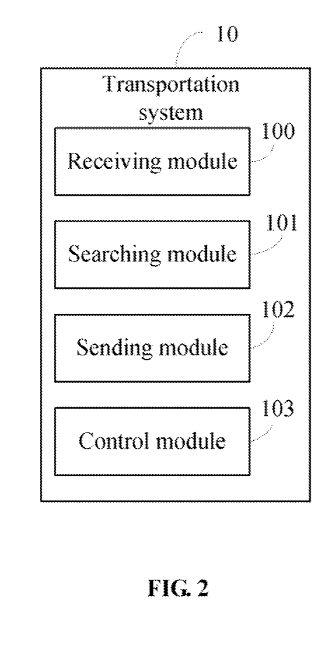

As shown in FIG. 2, the transportation system 10 may include a receiving module 100, a searching module 101, a sending module 102 and a control module 103.

The receiving module 100 receives the identification number of the goods 5 sent from the identification device 3.

The searching module 101 searches in the database server 2 for the goods information, which includes the serial number of the designated output guide rail 8 for transporting the goods 5, according to the identification number of the goods 5.

The sending module 102 sends a command including the serial number of the designated output guide rail 8 to the motor 6.

The control module 103 controls the motor 6 to turn the wheel 7 in a direction of the designated output guide rail 8 according to the serial number, and transports the goods 5 along the output guide rail 8 until the goods arrive at the destination station.

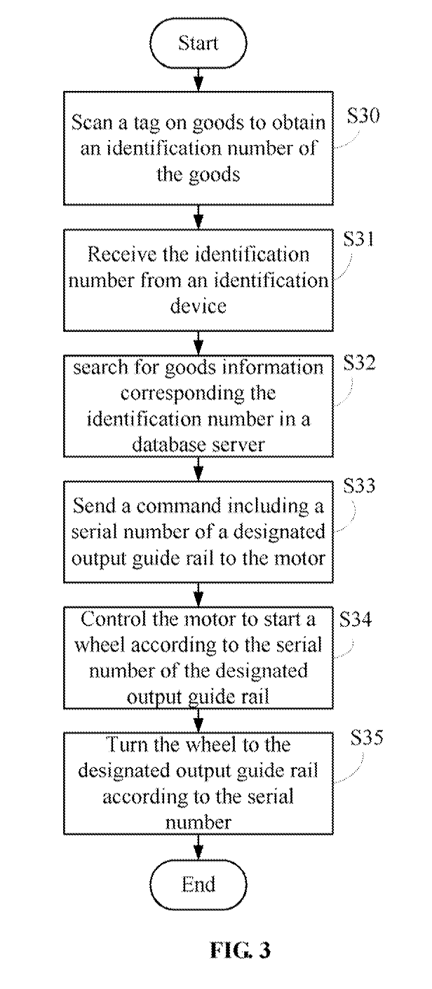

FIG. 3 is a flowchart illustrating a method for transporting goods. Depending on the embodiment, additional blocks may be added, others removed, and the ordering of the blocks may be changed.

In block S30, the sensor 30 senses the goods 5 which move on the input guide rail 4, the scanning device 31 scans the tag on the goods 5 for reading the identification number of the goods 5.

In block S31, the receiving module 100 receives the identification number from the identification device 3.

In block S32, the searching module 101 searches for the goods information corresponding the identification number in the database server 2.

In block S33, the sending module 102 sends a command which includes the serial number of a designated output guide rail 8 which is selected from the more than one output guide rails 8 to the motor 6.

In block S34, the control module 103 controls the motor 6 to start the wheel 7 according to the serial number of the designated output guide rail 8.

In block S35, the wheel 7 is rotated and turns to the designated output guide rail 8 corresponding to the serial number. The goods 5 are transported to the output guide rail 8 until arriving at the destination station.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. An application server, comprising:
a storage system;
at least one processor; and
one or more programs being stored in the storage system and executable by the at least one processor, the one or more programs comprising:
a receiving module operable to receive an identification number from a tag of goods sent from an identification device, if the goods are transported on an input guide rail;
a searching module operable to search for a serial number of a designated output guide rail selected from more than one output guide rails for transporting the goods in a database server according to the identification number;
a sending module operable to send the searched serial number to a motor; and
a control module operable to control the motor to rotate a wheel, which is between the input guide rail and the more than one output guide rail, to a direction of the designated output guide rail, and transport the goods to the designated output guide rail to carry the goods to a destination station.

2. The application server as described in claim 1, wherein the identification device comprises a sensor and a scanning device.

3. The application server as described in claim 2, wherein the sensor detects the goods which are transported on the input guide rail, and the scanning device scans the tag on the goods to obtain the identification number of the goods.

4. The application server as described in claim 1, wherein the database server stores information of the goods.

5. A computer-based method for transporting goods, comprising:
reading an identification number from a tag of the goods by an identification device, if the goods are transported on an input guide rail;
receiving the identification number from the identification device by an application server connected to the identification device;
searching for a serial number of a designated output guide rail selected from more than one output guide rails for transporting the goods in a database server according to the identification number;
sending the searched serial number to a motor; and
controlling the motor to rotate a wheel, which is between the input guide rail and the more than one output guide rail, to a direction of the designated output guide rail; and
transporting the goods to the designated output guide rail to carry the goods to a destination station.

6. The method as described in claim 5, further comprising:
detecting the goods which are transported on the input guide rail by a sensor; and
scanning the tag on the goods to obtain the identification number of the goods.

7. The method as described in claim 5, wherein the database server stores goods information the goods.

8. A non-transitory storage medium having stored thereon instructions that, when executed by a processor, cause the processor to perform a method for transporting goods, the method comprising:
reading an identification number from a tag of the goods by an identification device, if the goods are transported on an input guide rail;
receiving the identification number from the identification device by an application server connected to the identification device;
searching for a serial number of a designated output guide rail selected from more than one output guide rails for transporting the goods in a database server according to the identification number;
sending the searched serial number to a motor; and
controlling the motor to rotate a wheel, which is between the input guide rail and the more than one output guide rail, to a direction of the designated output guide rail; and transporting the goods to the designated output guide rail to carry the goods to a destination station.

9. The non-transitory storage medium as described in claim 8, further comprising:
detecting the goods which are transported on the input guide rail by a sensor; and
scanning the tag on the goods to obtain the identification number of the goods.

10. The non-transitory storage medium as described in claim 8, wherein the database server stores goods information the goods.
